(19) United States
(12) Patent Application Publication
(10) Pub. No.: US 2009/0214302 A1
(43) Pub. Date: Aug. 27, 2009

(54) Control of slurry flow

(75) Inventor: Hartmut Johannes Ilgner, Johannesburg (ZA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CSIR, Pretoria (ZA)

(21) Appl. No.: 11/918,847

(22) PCT Filed: Apr. 20, 2006
(86) PCT No.: PCT/IB2006/000934

§ 371 Date: Jan. 13, 2009

(30) Foreign Application Priority Data
Apr. 20, 2005 (ZA) 2005/03195

(51) Int. Cl. B65G 51/16; F17D 3/01

(52) U.S. Cl. 406/14

(57) ABSTRACT

One aspect of the invention concerns a method of controlling a flow of slurry pumped through a non-vertical pipeline (10) by a pump (54). In the method, at least one sensor (12) is provided. This has a sensing face (42), and the sensor is mounted at a predetermined position along the length of the pipeline such that the sensing face is flush with the invert of the pipeline at that position. The sensor is calibrated to provide output signals related to the velocity of the slurry at the invert. The operation of the pump and/or the density of the slurry are then controlled in response to the output signals from the sensor. Other aspects of the invention relate to the apparatus and to a slurry pipeline control system incorporating the apparatus and in which the method is implemented.

### BACKGROUND TO THE INVENTION

THIS invention relates to the control of slurry flow.

In this specification the term “slurry” is used for convenience to refer to conventional aqueous slurries in thickened or unthickened form, including tailings and pastes.

In one application, the invention may be used to control the flow of slurry in a pipeline conveying the slurry from a mineral processing plant to a slurry disposal dam or other site. By way of example, in the mining and mineral extraction industry, thickened slurry or tailings is pumped through pipelines from mineral extraction plants to tailings dams.

It is well established that the most economical operating condition for a given slurry is just above the critical deposition velocity. This critical velocity varies from case to case and is dependent on a number of different factors including concentration or density of the slurry, composition of the slurry, particle size distribution in the slurry, and so on. At velocities below the critical deposition velocity, solid particles in the slurry tend to settle in the pipeline to form either a sliding or stationary bed at the invert of the pipe section, which could in turn lead to pipeline blockage.

It is also recognized that operating costs will be increased if the slurry is pumped through the pipeline at a velocity substantially in excess of the critical deposition velocity, because more power will be consumed and there will be greater frictional losses and pipeline wear. Similarly if the concentration or density of the slurry is reduced by increasing the water content in order to decrease the critical deposition velocity, there may be an undesirable wastage of water and/or a costly requirement to pump water back from the disposal site.

If the slurry contains larger particles, they will tend to settle out first and this may lead to undesired, unstable operating conditions. Therefore despite the abovementioned disadvantages and increased operating costs associated with higher pumping velocities, slurry pumping systems are generally designed to operate at a safety margin above the critical deposition velocity to ensure operational stability and avoid pipeline blockages.

In reality, the slurry ultrafines content in the particle size distribution, the maximum particle size and the mineral composition may vary considerably during operation of a slurry pumping system. In an optimal system the flow velocity should be controlled continuously to an appropriately low value while the concentration of the slurry is maintained at an appropriately high value.

Numerous attempts have been made, with limited success, to achieve on-line optimisation of slurry pumping systems. Examples of such previous attempts, and the associated disadvantages, have been described in some detail in “Innovative Flow Control Philosophy, Based on Novel in-situ Measurements to Reduce Energy Consumption for Tailings Pipelines” by Ilgner H J (proc. 16^{th} Int. Conf. On Hydrotransport, BHR Group, Santiago, Chile).

### SUMMARY OF THE INVENTION

According to one aspect of the present invention there is provided a method of controlling a flow of slurry pumped through a non-vertical pipeline by a pump, the method comprising the steps of providing at least one sensor having a sensing face, mounting the or each sensor at a predetermined position along the length of the pipeline such that its sensing face is flush with the invert of the pipeline at that position, the sensor(s) being calibrated to provide output signals related to the velocity of the slurry at the invert at the predetermined position(s), and controlling the operation of the pump and/or the density of the slurry, in response to the output signals from the sensor(s).

Preferably the operation of the pump and/or the velocity of the slurry are controlled such that the velocity of the slurry in pipeline is maintained close to, usually slightly above, a critical deposition velocity for the slurry. Preferably also the or each sensor is arranged to provide continuous output signals related to the slurry velocity at the invert.

Conveniently the or each sensor is a thermal sensor, typically a thermal flow sensor calibrated to produce output signals related to slurry velocity at the pipeline invert rather than flow rate.

The method may be carried out such that in response to a signal output by a sensor that is indicative of a slurry velocity lower than a predetermined value, the speed of the pump is increased and the density of the slurry is decreased by increasing water addition to the slurry, or alternatively such that, in response to a signal output by a sensor that is indicative of a slurry velocity higher than a predetermined value, the speed of the pump is decreased and the density of the slurry is increased by decreasing water addition to the slurry.

In the preferred implementation of the method a first sensor is mounted at an upstream position in the pipeline to output signals related to the velocity of the slurry adjacent the pump and a second sensor is mounted at a downstream position in the pipeline to output signals related to the velocity of the slurry adjacent the end of the pipeline. Further sensors may be mounted at positions in the pipeline between the first and second sensors.

According to another aspect of the invention there is provided a slurry pipeline system comprising a non-vertical pipeline, a pump for pumping slurry through the pipeline, at least one sensor which has a sensing face, means for mounting the or each sensor at a predetermined position along the length of the pipeline such that its sensing face is flush with the invert of the pipeline at that position, the sensor(s) being calibrated to provide output signals related to the velocity of the slurry at the invert at the predetermined position(s), and means for controlling the operation of the pump and/or the density of the slurry in response to the signals output by the sensor(s).

The system may include a plurality of sensors, preferably thermal sensors, a first of which is mounted at an upstream position in the pipeline to output signals related to the velocity of the slurry adjacent the pump and a second sensor is mounted at a downstream position in the pipeline to output signals related to the velocity of the slurry adjacent the end of the pipeline. As indicated previously there may be further sensors mounted at intermediate positions in the pipeline between the first and second sensors.

In the preferred embodiment, the mounting means comprises a tubular stub fixed transversely to the wall of the pipeline, at the invert thereof, with the bore of the stub in communication with a hole in that wall and with the sensor located in the stub, means locking the sensor in the stub with a sensing face of the sensor flush with the invert surface of the wall and means sealing the sensor relative to the stub. Conveniently the stub has a threaded outer end and the locking means comprises a union nut located over the sensor and engaged with the threaded end of the stub.

Conveniently also the means sealing the sensor comprises O-rings providing seals between an inner end of the stub and the wall of the pipeline and between an outer end of the stub and the sensor respectively, an inlet leading to a space between the stub and the sensor, in a region between the respective O-rings, and filler material filling the space.

Another aspect of the invention provides an apparatus for controlling a flow of slurry pumped through a non-vertical pipeline by a pump, the apparatus comprising at least one sensor having a sensing face, means for mounting the or each sensor at a predetermined position along the length of the pipeline such that its sensing face is flush with the invert of the pipeline at that position, the sensor(s) being calibrated to provide output signals related to the velocity of the slurry at the invert at the predetermined position(s), and means for controlling the operation of the pump and/or the density of the slurry in response to the signals output by the sensor(s).

### BRIEF DESCRIPTION OF THE DRAWINGS

The invention will now be described in more detail, by way of example only, with reference to the accompanying drawings in which:

FIG. 1 shows a cross-sectional view illustrating the mounting of a thermal flow sensor on the wall of a slurry pipeline; and

FIG. 2 diagrammatically illustrates a system for controlling slurry flow in a pipeline.

### SPECIFIC DESCRIPTION

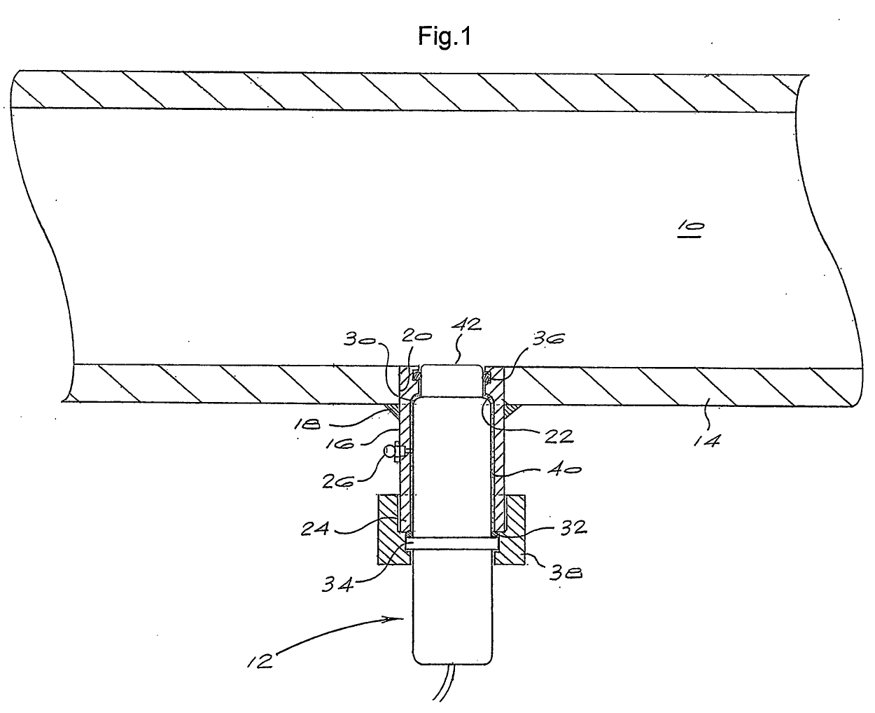

Referring firstly to FIG. 1 a section of a pipeline conveying pumped slurry, typically from a mineral processing plant in a mining operation, is indicated by the reference numeral 10.

Mounted to the pipeline 10 is a thermal flow sensor 12. The thermal flow sensor in this case is a FLOW-CAPTOR™ model flow sensor available from Weber Sensors GmbH of Germany.

The flow sensor 12 is mounted to the wall 14 of the pipeline by means of a mounting structure including a tubular stub 16 the inner end of which is welded at 18 into an opening 20 in the pipe wall, at the invert, i.e. lowest point, thereof. The stub includes an annular shoulder 22 near to its inner end and is externally threaded at its outer end 24. An inlet in the form of a grease nipple 26 is fitted to the side wall of the stub.

The bore of the stub receives the inner portion of the flow sensor 12 with an annular shoulder 30 towards the inner end of the sensor bearing against the shoulder 22 of the stub. An O-ring 32 is located between an annular collar 34 on the sensor and the outer end of the stub as shown. Another O-ring 36 is seated in an internal, annular groove at the inner end of the stub. The sensor is locked to the stub by means of a union nut 38 which bears on the collar 34 and is run up on the threaded outer end 24 of the stub. This compresses the O-ring 32 to create a seal between the stub and the sensor at the outer end of the stub.

Grease is injected under pressure through the grease nipple 26 into the annular space 40 between the sensor and the stub. The grease is held captive in the sealed space defined between the O-rings 32 and 36.

The mounting of the sensor is such that its inner, sensing face 42 is flush with the invert of the pipeline 10, i.e. at the lowest point of the pipeline. The sensing face 42 of the sensor is typically provided with an abrasion-resistant coating, such as a nickel-based or other special coating, to reduce the chances of damage to the sensing face when it is exposed to an abrasive flow of slurry in the pipeline 10.

It will be understood that the dimensions of the stub are carefully selected to ensure that the sensing face 42 of the sensor is located flush at the pipe invert. The grease in the space 40 prevents solid particles settling out of a slurry conveyed in the pipeline into the space. It also facilitates replacement of the sensor when necessary. Although specific mention has been made of grease it will be understood that other suitable filler materials may also be used.

FLOW-CAPTOR™-type sensors are self-heating sensors which make use of two longitudinally spaced apart temperature sensing probes situated adjacent the sensing face, a heating element and control circuitry which operates to maintain a constant temperature differential between the two probes. As a fluid passes the sensing face it removes heat, requiring addition of heat by the heating element operating under the control of the control circuitry in order to maintain the set temperature differential. Those skilled in the art and familiar with the operation of such thermal flow sensors will understand that such sensors are conventionally used, in accordance with the manufacturer's recommendations, to measure the flow rate of fluids such as liquids or gases in a pipeline. The sensor is calibrated to provide output signals which are dependent on the required heat input and hence on the rate of heat removal, which is in turn related to the flow rate of the fluid.

Skilled persons will also recognise that the described installation of the sensor, with the sensing face flush with the pipe invert, is contrary to the recommended installation of such instruments in their normal design usage for measuring flow rate in a pipeline. The manufacturer's recommendation for installation of the thermal flow sensor for flow-rate measurement is that the inner face of the sensor be positioned to protrude into the bore of the pipeline by at least 1/7 of the internal pipeline diameter so as to be exposed to turbulent flow conditions.

The thermal flow sensor 12 is not used in a conventional mode in the present invention. In this case it is used to sense velocity conditions prevailing at the invert of the pipeline, where laminar flow conditions could lead to the development of sliding and stationary bed conditions. In particular, the sensor 12 is calibrated prior to installation so that the signals which it outputs are indicative of the velocity of the slurry at the pipe invert. Calibration may be achieved empirically by, for instance, visual observation of slurry flow at different velocities in a transparent section of a test pipeline. Measurements can be taken of the time taken for coloured markers in the slurry flow to travel a given distance in order to allow calculation of actual velocity values which can be correlated to the signal outputs produced by the sensor 12.

In the present embodiment, heat generated by the heating element of the sensor is removed by slurry present at the pipe invert. It will be understood that a slurry moving at a relatively high velocity will remove heat from the sensor at a higher rate than a slurry moving at a relatively low velocity and that a stationary slurry, which arises at a condition of zero velocity at the pipe invert, i.e. formation of a stationary bed, will remove heat at the slowest rate. It will also be understood that the heat removal capability of the slurry is dependent on the type of slurry, slurry concentration and water content and other variable factors. The signals output by the sensor correspond to the heat which must be supplied by the heating element in order to maintain a constant temperature differential across the face. Calibration is accordingly carried out, for the particular slurry characteristics in question, such that a base output signal of, say, 4 mA is generated at a zero velocity condition and such that a maximum signal of, say, 20 mA is output at a condition of maximum velocity expected in the pipeline. Velocities between these extremes result in the output of intermediate signals of intermediate value.

A sensor 12, calibrated and installed in the manner described above, may be used to control slurry flow in the pipeline 10. The signal output by the sensor may for instance be used to control the operation of the pump, for example the rotational speed of a centrifugal pump or the stroke rate of a positive displacement pump, used to pump the slurry through the pipeline. For instance, in a situation where a condition of zero velocity exists at the pipeline invert, meaning that the slurry velocity has dropped below the critical deposition velocity and a stationary bed has developed at the invert, the sensor will output the baseline signal of 4 mA (in the example given above). On the basis of this signal a controller may then increase the speed of the pump in order to increase the slurry velocity to a greater value to avoid the stationary bed condition. Similarly if the signal output by the sensor is indicative of too high a slurry velocity, the controller may, on receipt of the signal, decrease the pump speed in order to reduce the slurry velocity.

Alternatively or in addition, signals output by the sensor 12 may be used to control the density of the slurry in order to optimise the operation of the slurry pumping system. This is explained below in more detail.

Although only a single sensor has been mentioned, the invention envisages the provision of a second, back-up sensor a short distance, say 100 mm, away from the first sensor in order to provide a back-up signal in the event of failure of the first sensor. The second sensor would be mounted in the same way as the first sensor, i.e. at the pipe invert.

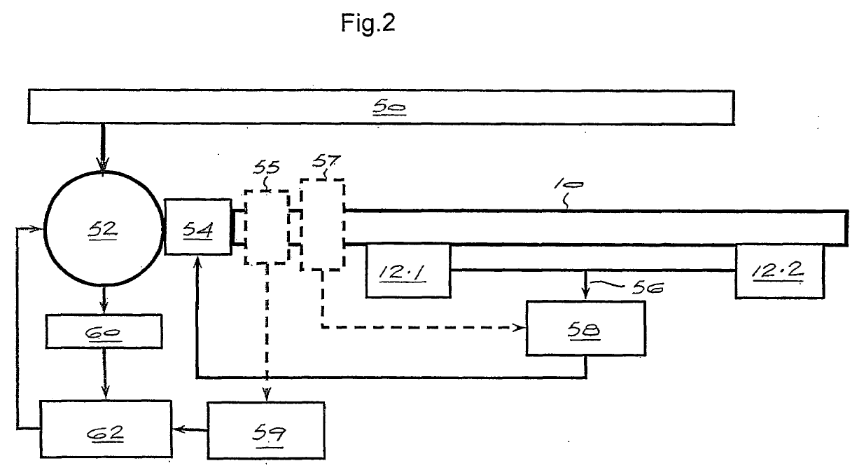

FIG. 2 shows a particularly preferred slurry control system. In this Figure the numeral 50 indicates a source of variable slurry. This may for instance be a mineral processing plant. The numeral 52 indicates a mixing tank in which water is added to the slurry to form a slurry of required density or to increase the slurry volume with a view to maintaining a suitably high flow rate. The slurry is pumped from the tank 52, through the pipeline 10, by a pump 54 which may be either a centrifugal pump for relatively dilute slurries such as tailings or a positive displacement pump for denser slurries and pastes.

The system includes an upstream thermal sensor 12.1, calibrated and installed as described above, located close to the pump 54. The sensor 12.1 provides early detection of low velocity conditions at the pipe invert as a result, for instance, of introduction of coarser particles into the feed slurry and the tendency of such particles to settle out rapidly in a pipeline system set up for finer material. There is also a similarly calibrated and installed downstream sensor 12.2, in this case towards the end of the pipeline, to detect the onset of a sliding bed condition which might develop as a result of laminar flow conditions in the pipeline and gradual settlement of particles which are initially entrained in the slurry flow. This could be particularly important in the case of slurries in the form of dense pastes.

Each diagrammatically represented sensor 12.1, 12.2 could in fact include multiple sensors as described above.

The system may, as indicated in broken outline, also include a density gauge 55 and a flowmeter 57 at the upstream end of the pipeline.

In use, detection of low velocity conditions by either sensor results in the output of a control signal 56 to a controller 58 which controls the operation of the pump 54. In this situation, the pump speed is increased in order to avoid excessive settlement in the pipeline, the formation of sliding bed conditions at the pipeline invert, and possible subsequent blockage of the pipeline, i.e. to ensure that the the velocity is maintained above the critical deposition velocity for the slurry in question.

On the other hand, if unacceptably high velocities are detected by the sensors, the pump speed may be gradually decreased. The slurry level in the tank 52, as monitored by a tank level monitor 60, will then increase if the slurry supply from the source 50 is maintained. In this case it is desirable to reduce the amount of dilution water added to the slurry in the tank 52 in order to maintain a suitable tank level. This can be achieved by a density controller 59 which controls the operation of the water supply 62. The decrease in the water addition results in an increase in the slurry density and allows a design slurry flow rate to be maintained in the pipeline.

In this situation there is an energy saving benefit both as a result of reduction of the pump speed but also as a result of a reduced requirement to pump dilution water back from, for example a tailings dam fed by the pipeline 10, thereby reducing energy consumption by the return pumps.

Where the pump speed has been increased in order to avoid a possible critical deposition velocity, water addition to the slurry in the tank 52 may be increased in order to maintain the desired tank level and flow rate in the pipeline.

Velocity output signals from the sensors 12.1 and 12.2 may also be used to control the slurry density.

In each case, the density gauge 55 and flowmeter 57 are used to provide feedback signals indicative of the relevant parameters, thereby to assist in ensuring that a desired tonnage throughput of material is maintained.

As indicated previously it is also within the scope of the invention to provide further sensors spaced apart along the length of the pipeline in order to enable a determination to be made as to where settlement first starts in the slurry flow and to generate appropriate control signals for optimising the operation of the system.

The objective of the control provided by the system described above will in each case generally be to optimise the slurry pumping operation by, for instance, ensuring that the slurry is pumped at a suitably low velocity, typically close to the critical deposition velocity for the slurry in question and a suitably high density, i.e. a suitably low water content, thereby to save operating costs, energy and water for a required flow rate, i.e. tonnage throughput per unit time. It will be understood that the apparatus described above allows for continuous and automatic control of the relevant operating parameters as the characteristics of the feed slurry, for example composition, particle size distribution and so on vary with time.

It is envisaged that the real time data provided by the sensor(s) at the pipeline invert can be linked to other information, for example the cost of water and electricity, in order to provide knowledge about the most economical operating parameters for different slurries.

Although specific mention has been made of controlling slurry flow in pipelines, it is also envisaged that the invention will have a wide range of other applications. The principles of the invention could for instance be used in thickeners and batch settling tanks to provide an indication of the sedimentation level (corresponding to a low velocity condition in the pipeline application), or to identify “dead” zones in such vessels where there is no fluid movement. The same principles could also be used to monitor and control flow in conduits other than closed pipelines, for instance open chutes and channels, or in hydrocyclones.

Although specific mention has been made of the use of the FLOW-CAPTOR™ type sensor, the invention envisages that other types of sensor, suitable for monitoring conditions at the pipeline invert, may also be used. Other examples include the T-TREND™ or MAGPHANT™ type sensors available from Endress & Hauser. While the former sensor is also a thermal sensor, the latter sensor operates on magnetic field principles rather than thermal principles. In both cases, the sensors are mounted flush at the pipeline invert so as to sensitive to the slurry velocity at the invert.

1. A method of controlling a flow of slurry pumped through a non-vertical pipeline by a pump, the method comprising the steps of providing at least one sensor having a sensing face, mounting the or each sensor at a predetermined position along the length of the pipeline such that its sensing face is flush with the invert of the pipeline at that position, the sensor(s) being calibrated to provide output signals related to the velocity of the slurry at the invert at the predetermined position(s), and controlling the operation of the pump and/or the density of the slurry, in response to the output signals from the sensor(s).

2. A method according to claim 1 wherein the operation of the pump and/or the velocity of the slurry are controlled such that the velocity of the slurry in pipeline is maintained close to or just above a critical deposition velocity for the slurry.

3. A method according to claim 1, wherein the or each sensor is arranged to provide continuous output signals related to the slurry velocity at the invert.

4. A method according to claim 1, wherein the or each sensor is a thermal sensor.

5. A method according to claim 1 wherein, in response to a signal output by a sensor that is indicative of a slurry velocity lower than a predetermined value, the speed of the pump is increased and the density of the slurry is decreased by increasing water addition to the slurry.

6. A method according to claim 1 wherein, in response to a signal output by a sensor that is indicative of a slurry velocity higher than a predetermined value, the speed of the pump is decreased and the density of the slurry is increased by decreasing water addition to the slurry.

7. A method according to claim 1, wherein a first sensor is mounted at an upstream position in the pipeline to output signals related to the velocity of the slurry adjacent the pump and a second sensor is mounted at a downstream position in the pipeline to output signals related to the velocity of the slurry adjacent the end of the pipeline.

8. A method according to claim 7 wherein further sensors are mounted at positions in the pipeline between the first and second sensors.

9. A slurry pipeline system comprising a non-vertical pipeline, a pump for pumping slurry through the pipeline, at least one sensor which has a sensing face, means for mounting the or each sensor at a predetermined position along the length of the pipeline such that its sensing face is flush with the invert of the pipeline at that position, the sensor(s) being calibrated to provide output signals related to the velocity of the slurry at the invert at the predetermined position(s), and means for controlling the operation of the pump and/or the density of the slurry in response to the signals output by the sensor(s).

10. A system according to claim 9 wherein the sensor(s) are thermal flow sensor(s).

11. A system according to claim 9 comprising a plurality of sensors a first of which is mounted at an upstream position in the pipeline to output signals related to the velocity of the slurry adjacent the pump and a second sensor is mounted at a downstream position in the pipeline to output signals related to the velocity of the slurry adjacent the end of the pipeline.

12. A system according to claim 11 comprising further sensors mounted at intermediate positions in the pipeline between the first and second sensors.

13. A system according to claim 9, wherein the mounting means comprises a tubular stub fixed transversely to the wall of the pipeline, at the invert thereof, with the bore of the stub in communication with a hole in that wall and with the sensor located in the stub, means locking the sensor in the stub with a sensing face of the sensor flush with the invert surface of the wall and means sealing the sensor relative to the stub.

14. A system according to claim 13 wherein the stub has a threaded outer end and the locking means comprises a union nut located over the sensor and engaged with the threaded end of the stub.

15. A system according to claim 14 wherein the means sealing the sensor comprises O-rings providing seals between an inner end of the stub and the wall of the pipeline and between an outer end of the stub and the sensor respectively, an inlet leading to a space between the stub and the sensor, in a region between the respective O-rings, and a filler material filling the space.

16. An apparatus for controlling a flow of slurry pumped through a non-vertical pipeline by a pump, the apparatus comprising at least one sensor having a sensing face, means for mounting the or each sensor at a predetermined position along the length of the pipeline such that its sensing face is flush with the invert of the pipeline at that position, the sensor(s) being calibrated to provide output signals related to the velocity of the slurry at the invert at the predetermined position(s), and means for controlling the operation of the pump and/or the density of the slurry in response to the signals output by the sensor(s).

17. An apparatus according to claim 16 wherein the sensor(s) are thermal flow sensor(s).

18. An apparatus according to claim 17 wherein the means for mounting the sensor at a predetermined position along the length of a pipeline comprises a tubular stub to be fixed transversely to the wall of the pipeline, at the invert thereof, with the bore of the stub in communication with a hole in that wall, the stub being dimensioned to receive a thermal sensor, means for locking the sensor in the stub with a sensing face of the sensor flush with the inner surface of the wall and means for sealing the sensor relative to the stub.

19. An apparatus according to claim 18 wherein the stub has a threaded outer end and the means for locking the sensor in the stub comprises a union nut locatable over the sensor and engaged with the threaded end of the stub.

20. An apparatus according to claim 19 wherein the means for sealing the sensor comprises O-rings for providing a seal between an inner end of the stub and the wall of the pipeline and between an outer end of the stub and the sensor respectively, and an inlet for introduction of a sealing material between the stub and the sensor in a region between the O-rings.
